(19) United States
(12) Patent Application Publication
(10) Pub. No.: US 2010/0102976 A1
(43) Pub. Date: Apr. 29, 2010

(54) SYSTEM AND METHOD FOR MONITORING VIBRATION OF POWER TRANSFORMER

(75) Inventors: Wook Ryun Lee, Daejeon (KR); Jun Shin Lee, Daejeon (KR); Yong Chae Bae, Daejeon (KR); Byong Han Kim, Daejeon (KR); Sang Kil Lee, Daejeon (KR)

Correspondence Address: MARTINE PENILLA & GENCARELLA, LLP, 710 LAKEWAY DRIVE, SUITE 200, SUNNYVALE, CA, 94085, US

(73) Assignee: Korea Electric Power Corporation, Seoul (KR)

(21) Appl. No.: 12/345,542

(22) Filed: Dec. 29, 2008

(30) Foreign Application Priority Data
Oct. 23, 2008 (KR) 2008-0104211

(51) Int. Cl. G08B 21/18; G01M 7/00

(52) U.S. Cl. 340/646; 73/659

(57) ABSTRACT

The present invention provides a system and method for monitoring vibration of a power transformer. The system comprises at least one vibration sensor operably mounted to the outer case of a transformer for sensing vibration of the power transformer; a spectrum analyzer for processing the vibration signal from the vibration sensor, the spectrum analyzer generating a frequency spectrum of the vibration signal and calculating a velocity rating from the frequency spectrum; a diagnosing means for evaluating the velocity rating of the vibration signal, the diagnosing means assigning a vibration grade for each velocity rating, the diagnosing means finding the maximum velocity rating; and a means for dispatching a control message to an operator when the maximum velocity rating reaches a threshold value. It can be appreciated that the mechanical health of a large-sized transformer can be managed in a systematic and efficient manner during its operation. This system can prevent accidents due to the mechanical failure of the transformer or diagnosing failure of the transformer itself during its operation. This system also can provide useful information to determine when the transformer has to be replaced and further to predict what the expected lifespan of the transformer will be.

### BACKGROUND OF THE INVENTION

1. Field of the Invention

The present invention relates generally to a system and method for monitoring vibration of a power transformer, and more specifically, to a system and method for monitoring vibration of a power transformer capable of analyzing the vibration of the power transformer on a real time basis to systematically manage the mechanical health of the power transformer.

2. Description of the Related Art

Generally, a power transformer is important equipment used for supplying electric power at a power plant, electric power transforming or transmitting station. The power transformer requires a high reliability in its operation and continuous maintenance thereof. Since a transformer failure brings a catastrophic accident or damages, the transformer needs continuous inspection and pre-remedial measure during its manufacturing process as well as installing or operating stages thereof.

Various monitoring systems for analyzing operation parameters, such as temperature, voltage or current or the like have been employed in the art. Meanwhile, an interruption in the supply of electricity, i.e., power outage is frequently reported. Most of such power outages are attributed to the transformer failure which is caused by electrical or mechanical defect. The electrical defect appears to be relatively well monitored and inspected during the supply of the electric power. However, the mechanical defect, e.g., vibration of the outer case of the transformer or its associated components caused by resonance seems not to be continuously monitored during the operation. Particularly, considering the operational features of a large-sized transformer installed at a power plant, it can be noted that most of the accidents other than an abrupt failure, e.g., earth faults occur when trivial defects at issue have been accumulated for a long period of time. Thus, a need has arisen for continuously monitoring the operational state of the transformer, and the monitoring results are to be compiled into a database so as to maintain and supplement them in a continuous manner.

Recently, there have been frequent reports about a catastrophic transformer failure which was caused by resonance of the outer case of the transformer due to the critical vibration. Accordingly, it can be appreciated that there needs to develop a system for monitoring the health, i.e., the condition of the transformer where symptoms of the failure can be diagnosed early and managed properly while operating the transformer.

In this regard, a variety of devices and methods for monitoring the operational state of the transformer or other electric power equipments in a remote site are known and described, for example, in Korean Patent Nos. 03371844 and 0817611. As described in these patents, a power transformer or a variety of electric power equipment is continuously monitored to obtain data regarding operational parameters. The retrieved data is processed to operate the transformer in an optimal state. The monitoring methods disclosed in those patents are disadvantageous in that they lack one of the core technologies capable of managing the vibration of the transformer during its operation. Further, it can be appreciated that those patents are more or less similar to this invention in the aspect of providing the optimal operation of electric equipment, particularly a transformer, but they can be applied only to a restricted area of technology, i.e., a small-sized transformer. In addition, they monitor the limited number of operational parameters, such as temperature, voltage and current of the transformer so that they cannot manage the overall mechanical health of the transformer. In other words, since they monitor and manage only the electrical characteristics of the transformer, they cannot diagnose the symptoms of the transformer failure due to vibration, mechanical or structural problems of the transformer. Other devices and methods for remotely monitoring the operation of the transformer are disclosed, for example, in U.S. Patent Application No. 20070225945 A1 and PCT Patent Publication No. WO 06/135994. Although these patents propose useful methods for continuously monitoring and diagnosing the power transformer in a remote site, they still lack a disclosure about mechanical defects due to vibration of the power transformer.

### SUMMARY OF THE INVENTION

With the foregoing drawbacks in mind, it is therefore an object of the invention to provide a system for monitoring the vibration of a power transformer that can monitor and diagnose the vibration of a power transformer with ease and simplicity to reduce the probability of the transformer failure and the unscheduled downtime.

It is another object of the invention to provide a method for monitoring the vibration of the power transformer by analyzing the vibration signal on a real time basis so that it can provide an efficient management system to predict the replacement time of the transformer and the expected lifespan of the transformer.

According to one aspect of the invention, there is provided a system for monitoring the vibration of a power transformer comprising: at least one vibration sensor operably mounted to the outer case of a transformer for sensing vibration of the power transformer; a spectrum analyzer for processing the vibration signal from the vibration sensor, the spectrum analyzer generating a frequency spectrum of the vibration signal and calculating a velocity rating from the frequency spectrum; a diagnosing means for evaluating the velocity rating of the vibration signal, the diagnosing means assigning a vibration grade for each velocity rating, the diagnosing means finding the maximum velocity rating; and a means for dispatching a control message to an operator when the maximum velocity rating reaches a threshold value.

In accordance with a preferred embodiment of the present invention, the vibration sensor may be an accelerometer.

In accordance with a preferred embodiment of the present invention, the system may further comprise a database for storing the vibration analysis data.

In accordance with a preferred embodiment of the present invention, the system may transmit the graded data through a network to an operator's computer in a remote site which is connected to a separate main computer.

According to another aspect of the invention, there is provided a method for monitoring vibration of a power transformer, comprising the steps of: obtaining vibration signal from a vibration sensor mounted to the outer case of the transformer; analyzing the vibration signal transmitted from vibration sensor using a fast Fourier transform; evaluating the analyzed vibration signal to decide the mechanical health of the transformer; and dispatching a control message to an operator when the evaluated vibration signal reaches a threshold value.

### BRIEF DESCRIPTION OF THE DRAWINGS

The above and other objects, features and other advantages of the present invention will become apparent from a review of the following detailed description of the preferred embodiment taken in conjunction with the accompanying drawings, in which:

FIG. 1 is a view schematically illustrating the construction of a system for monitoring the vibration of a power transformer in accordance with the invention;

FIG. 2 is a partial perspective view schematically showing the outer case of a power transformer and the location of vibration sensors mounted thereto in accordance with the invention;

FIG. 3 is an exemplary graphical representation illustrating a frequency spectrum with respect to the vibration signal from vibration sensors in accordance with the invention;

FIG. 4 is a table illustrating the table of a vibration grade divided into Grade A through Grade E in accordance with the present invention.

FIG. 5 is a graphical representation illustrating the relationship between the velocity rating (VR) and the frequency of the vibration signal.

FIG. 6 is a flowchart illustrating the steps for monitoring the vibration of a power transformer in accordance with the invention.

### DETAILED DESCRIPTION OF THE PREFERRED EMBODIMENTS

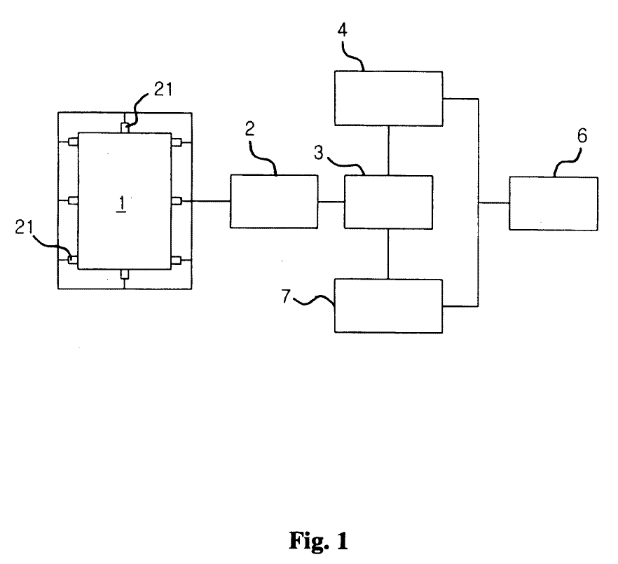

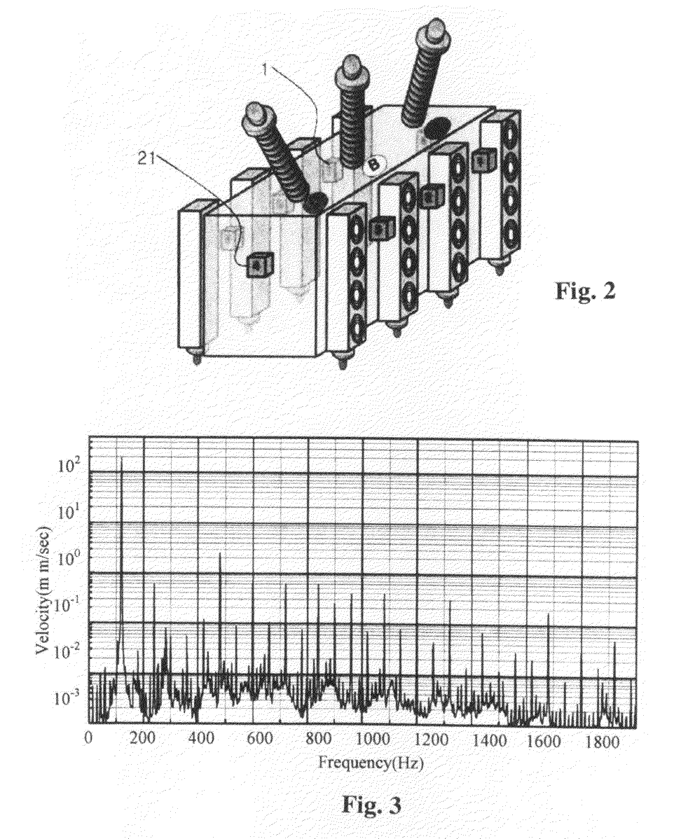

The other objects, features, advantages of the invention will become apparent from a review of the following detailed description of the preferred embodiment taken in conjunction with the accompanying drawings. FIG. 1 is a view schematically illustrating the construction of a system for monitoring the vibration of a power transformer in accordance with the invention. Referring to FIG. 1, the system for monitoring the vibration of the power transformer in the preferred embodiment of the present invention comprises a transformer body 1 having a vibration sensor 21, e.g., accelerometer mounted thereon, a control panel 2, a database 3, a monitoring system 4, an expert system 7 and an operator's personal computer 6. FIG. 2 is a partial perspective view showing that at least one vibration sensor 21 is mounted on the predetermined location on the outer case of the transformer body 1. The number of the vibration sensors to be attached and their locations are empirically determined after reviewing the vibration characteristics of the transformer. Generally, the location may be the place where the vibration occurs in large amplitude or it can indicate well about the operational state of the transformer. The transformer shown in FIG. 2 is a three-phase integral type transformer having eight vibration sensors 21 on the predetermined locations on the outer case thereof.

As shown in FIGS. 1 and 2, each vibration sensor 21 or accelerometer is adapted to sense the mechanical vibration of the transformer body 1, convert it into an electrical vibration signal and transmit it to the control panel 2. The control panel 2 having a spectrum analyzer (not shown) analyzes the vibration signal on a real time basis and generates a frequency spectrum therefrom. Since processing an analog vibration signal into digital form to get the frequency spectrum using an A/D converter, a CPU or the like is readily apparent to those having ordinary skill in the art, further description related thereto is omitted. The exemplary frequency spectrum obtained by the spectrum analyzer is illustrated in FIG. 3. In FIG. 3, the x-axis stands for frequency (Hz) and y-axis represents a magnitude of a velocity of the vibration (mm/sec).

The spectrum analyzer further calculates a velocity rating (VR) from the frequency spectrum using a fast Fourier transform (FFT) analysis. The result of such analysis is illustrated in FIG. 5, which shows the relationship between the velocity rating (VR) and the frequency of the vibration signal. Referring to FIG. 5, the x-axis indicates a frequency (Hz) and y-axis represents a vibration level or velocity rating (VR). The major frequency which significantly contributes to the vibration level of the transformer is approximately at 120 Hz, and a harmonic component also contributes to the vibration level. With respect to a normal main transformer, the vibration level is very small when the frequency is below 10 Hz and above 240 Hz. Here, the value of the velocity rating (VR) will correspond to the value between 3.15 and 100, and the latter value generally means the threshold value to determine whether it needs to send an alert message to the operator in order to check or stop the operation of the transformer.

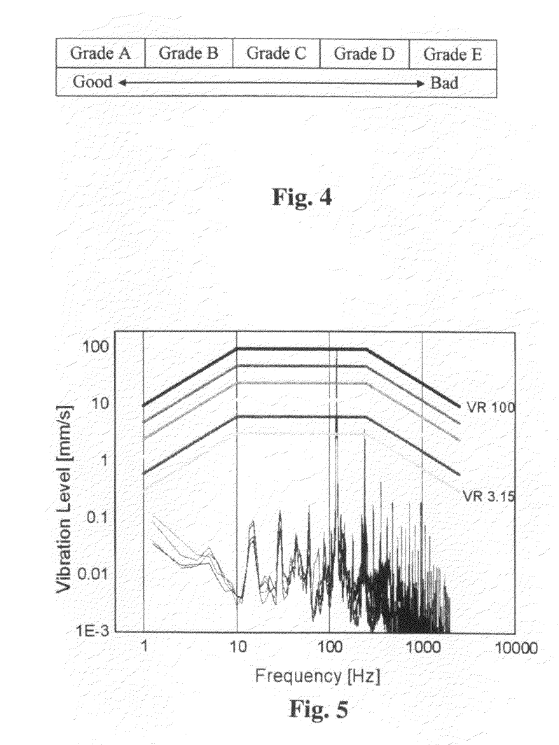

The result of the analysis by the spectrum analyzer is stored in the database 3 which is a storage device or memory. At the same time, the result of the analysis is transmitted to the expert system 7 having a diagnosing unit (not shown) via a separate communication network 5. The communication network 5 may be the Internet or LAN. The diagnosing unit in the expert system 7 is designed to evaluate the velocity rating (VR) of the frequency spectrum of the vibration signal. The diagnosing unit then assigns a vibration grade for each vibration signal as described in detail hereinbelow. The diagnosing unit compares each velocity rating (VR) with the value of the historical velocity ratings (VR) stored in the database 3 which are transmitted through the monitoring system 4. After comparing the velocity ratings, the diagnosing unit finds the maximum velocity rating (VRmax). The diagnosing unit of the expert system 7 has a separate guideline for assigning a various level of the vibration grade as shown in FIG. 4 with respect to each velocity rating (VR).

Referring to FIG. 4, there is provided with a table of the vibration grade divided into Grade A through Grade E in accordance with the present invention. The velocity rating(VR) processed in the expert system 7 corresponds to one of the grades from Grade A to Grade E. Grade A stands for an allowable vibration level which can be seen at the time of new installation of the transformer. Grade B illustrates a vibration level where the current operation of the transformer can be maintained for a long period time without any restriction. Grade C means a vibration level where a continuous operation is not allowed and a certain maintenance work is needed. Grade D indicates a vibration level which can damage the transformer or other associated components thereof but allow its operation while continuously monitoring thereof. Grade E illustrates a vibration level which needs to stop the operation for an immediate maintenance or repair work. Each grade identified by diagnosing unit in the expert system 7 is transmitted to the operator's computer 6 via the communication network 5 and also stored in the database 3 on a regular basis for the future use.

When the diagnosing unit in the expert system 7 finds the maximum velocity rating (VRmax), it compares the maximum velocity rating (VRmax) with the reference value extracted from the database 3. That is, the diagnosing unit decides whether the maximum velocity rating (VRmax) correspond to Grade D (a low threshold value) or Grade E (a high threshold value). If the maximum velocity rating (VRmax) corresponds to one of them, it dispatches a control message to the operator's computer 6. Accordingly, the operator can recognize that the transformer needs a certain action by the operator due to the mechanical failure or the like.

Meanwhile, the operator can use the maintenance manual provided in the expert system 7 and collect information about cause of the transformer failures, e.g., accident relating to the vibration level equal to or greater than Grade E. Thus the operator can find appropriate remedial measures thereto so that the management of the operation of the transformer can be performed with great efficiency. If the related vibration analysis data obtained as above has been accumulated for several years, such data can be used for predicting the expected lifespan of the transformer by way of analyzing the transitional change of the vibration with respect to the operation time. Further, such data can be utilized as a good source for making a determination as to the appropriate time when the transformer has to be replaced or to predict the expected lifespan of the transformer.

Hereinafter, the method for monitoring vibration of the power transformer in accordance with the invention will now be described in detail.

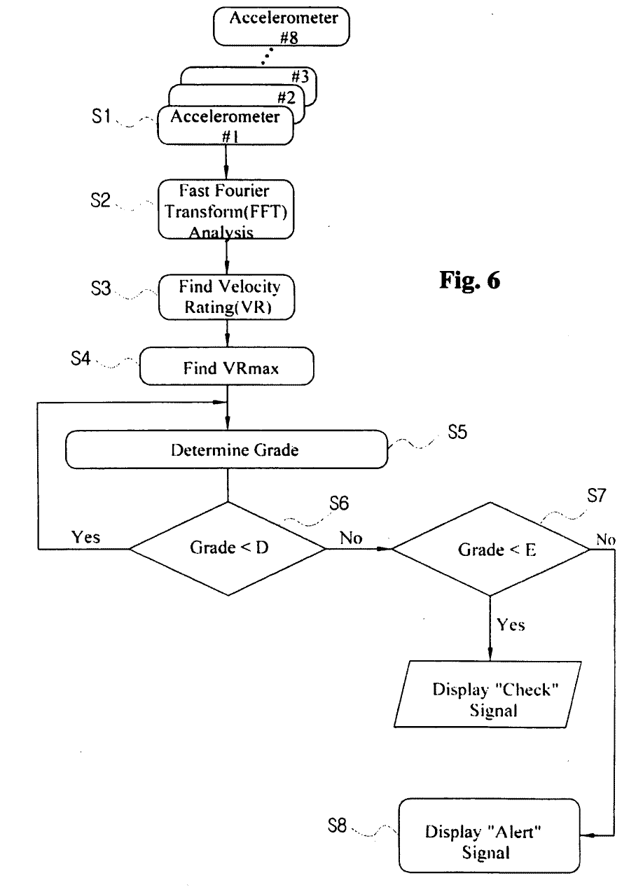

Referring to FIG. 6, there is shown a flowchart illustrating the steps for monitoring the vibration of the transformer. The vibration sensor 21 or accelerometer senses the mechanical vibration of the transformer and generates an electrical vibration signal at step S1. When the vibration signal in the form of analog signals is transmitted to the control panel 2, it is converted to digital form via A/D converter (not shown). Then the digital vibration signal is processed using a fast Fourier transform (FFT) analysis to obtain a frequency spectrum by means of a spectrum analyzer provided in the control panel 2 at step S2. The spectrum analyzer generates a corresponding frequency spectrum for each vibration signal received on a real time basis. The exemplary frequency spectrum obtained by the spectrum analyzer is shown in FIG. 3. The spectrum analyzer further calculates a velocity rating (VR) for each frequency spectrum using a fast Fourier transform (FFT) analysis at step S3. As results, a graph representing the velocity rating (VR) can be superimposed on the graph of the frequency spectrum as shown in FIG. 5.

Since the vibration is generated with a certain value or level, each and every vibration signal is processed to obtain a corresponding velocity rating (VR) as described hereinabove. The diagnosing unit provided in the expert system 7 compares each velocity rating (VR) transmitted through the monitoring system 4 with the values stored in the database 3 and finds the maximum velocity rating (VRmax) at step S4. At step S5, the diagnosing unit in the expert system 7 compares the vibration signal having the maximum velocity rating (VRmax), with the reference data comprising of Grade A through Grade E. That is, at step S6, the diagnosing unit compares the maximum velocity rating (VRmax) with the referenced grade value stored in the database 3 and determines whether the maximum velocity rating (VRmax) is equal to or greater than Grade D, i.e., a low threshold value. If the maximum velocity rating (VRmax) is smaller than the Grade D, the diagnosing unit generates a signal to maintain the current operation of the transformer.

Meanwhile, if the maximum velocity rating (VRmax) is equal to or greater than the grade D, the diagnosing unit compares again it with the grade E i.e., a high threshold value at step S7. If the maximum velocity rating (VRmax) is smaller than the grade E, the diagnosing unit outputs a signal to display a “Check” message which allows the operator to check the operational state of the transformer. If the maximum velocity rating (VRmax) is equal to or greater than the grade E, the diagnosing unit outputs a signal to display an “Alert” message to the operator's computer 6. Accordingly, the operator recognizes that the transformer is in mechanical failure and decides whether the transformer needs to be immediately stopped for a repair or maintenance work. The repair or maintenance work may be performed during the operation of the transformer or after the transformer is completely shut down.

The present invention provides a variety of technical ideas which can be applied in the vibration-related industry field as follows: a monitoring technology for sensing the vibration of the transformer and its associated components on a real time basis; a signal processing technology for analyzing the vibration signal using a fast Fourier transform; a development of a guideline for grading a vibration signal; a diagnosing technology for evaluating the velocity rating of the vibration signal; and a remote management technology for performing the optimal operation of the transformer in a remote site.

The present invention proposes a system capable of evaluating and managing the mechanical health of the transformer that cannot be achieved by the conventional technology. The inventive system can realize an optimal operation of the transformer by way of analyzing the vibration signal other than voltage, current or temperature of the transformer during its operation. The system can process and diagnose the vibration of the transformer on the remote computer or by the operator working in a remote site.

As described hereinabove, with application of the monitoring system and method of the present invention, it can be appreciated that the mechanical health of a large-sized transformer which is generally installed in the power plant, electric power transforming or transmitting station can be managed in a systematic manner. This system further can be employed for preventing the accident due to the mechanical failure of the transformer or diagnosing failure of the transformer itself. If the processed data has been stored for a long period of time, the data can provide important information to determine the appropriate time when the transformer has to be replaced or to predict the expected lifespan of the transformer.

While the invention has been described with reference to a preferred embodiment, it should be apparent to those skilled in the art that many changes and modifications may be made without departing from the spirit and scope of the invention as defined in the claims.

What is claimed is:

1. A system for monitoring the vibration of a power transformer comprising:
at least one vibration sensor operably mounted to the outer case of a transformer for sensing vibration of the power transformer;
a spectrum analyzer for processing the vibration signal from the vibration sensor, the spectrum analyzer generating a frequency spectrum of the vibration signal and calculating a velocity rating from the frequency spectrum;
a diagnosing means for evaluating the velocity rating of the vibration signal, the diagnosing means assigning a vibration grade for each velocity rating, the diagnosing means finding the maximum velocity rating; and
a means for dispatching a control message to an operator when the maximum velocity rating reaches a threshold value.

2. The system as recited in claim 1, wherein at least one vibration sensor is an accelerometer.

3. The system as recited in claim 1, further comprising a database for storing vibration analysis data.

4. The system as recited in claim 1, wherein the diagnosing means transmits vibration grade data through a network to an operator's computer in a remote site which is connected to a separate main computer.

5. The system as recited in claim 1, wherein the frequency region of the vibration signal is between 10 Hz and 240 Hz.

6. The system as recited in claim 1, wherein the spectrum analyzer processes the vibration signal using a fast Fourier transform.

7. A method for monitoring the vibration of a power transformer, comprising the steps of:
obtaining vibration signal from a vibration sensor mounted to the outer case of the transformer;
analyzing the vibration signal transmitted from vibration sensor using a fast Fourier transform;
evaluating the analyzed vibration signal to decide the mechanical health of the transformer; and
dispatching a control message to an operator when the evaluated vibration signal reaches a threshold value.

8. The method as recited in claim 7, wherein at least one of the vibration sensors is an accelerometer.

9. The method as recited in claim 7, wherein the analyzing step calculates a velocity rating from a frequency spectrum using a fast Fourier transform analysis.

10. The method as recited in claim 9, wherein the analyzing step uses the frequency region of the vibration signal between 10 Hz and 240 Hz.

11. The method as recited in claim 10, wherein the magnitude of the velocity rating corresponding to the frequency region of the vibration signal is between 3.15 and 100.

12. The method as recited in claim 7, wherein the evaluating step uses a database for retrieving the historical vibration analysis data.

13. The method as recited in claim 12, wherein the evaluating step further includes the step of comparing each velocity rating with the stored reference data.

14. The method as recited in claim 13, wherein the evaluating step uses a vibration grade comprising of Grade A through Grade E, each grade corresponding to a specific vibration level of the transformer.

15. The method as recited in claim 14, wherein the evaluating step finds the maximum velocity rating from the frequency spectrum of the vibration signal.

16. The method as recited in claim 15, wherein the dispatching step compares the maximum velocity rating with the stored value of the vibration grade and generates a control signal to the operator.

17. The method as recited in claim 16, wherein the dispatching step generates a control message to maintain the current operation of the transformer when the maximum velocity rating is smaller than a low threshold value.

18. The method as recited in claim 16, wherein the dispatching step generates a control message to check the operational state of the transformer when the maximum velocity rating is equal to or greater than a low threshold value but smaller than a high threshold value.

19. The method as recited in claim 16, wherein the dispatching step generates a control message to immediately stop the operation of the transformer for a repair or maintenance work when the maximum velocity rating is equal to or greater than a high threshold value.
